(19) United States
(12) Patent Application Publication
(10) Pub. No.: US 2025/0327533 A1
(43) Pub. Date: Oct. 23, 2025

(54) POWER-ASSISTED TRACK STOP VALVE

(71) Applicant: Jingang Huang, Karamay (CN)

(72) Inventors: Jingang Huang, Karamay (CN); Jieyuan Li, Karamay (CN); Wanli Peng, Karamay (CN); Yi Fei, Karamay (CN)

(21) Appl. No.: 18/639,240

(22) Filed: Apr. 18, 2024

(51) Int. Cl. F16K 31/52; F16K 1/38

(52) U.S. Cl. CPC F16K 31/52; F16K 1/38; F16K 31/522; F16K 31/528; F16K 31/5284

(57) ABSTRACT

A power-assisted track stop valve comprises a lower valve body, an upper valve body is detachably fixed on the top of the lower valve body, a lead screw is arranged inside the upper valve body; positioning pins are arranged on the inner side of the upper part of the upper valve body, guiding slots are arranged on the upper part of the outside of the lead screw at positions corresponding to the positioning pins, the positioning pins on the same side extend to the inside of the guiding slots on the same side; a valve core, which is arranged inside the lower valve body, the valve core is movably connected to the lower valve body, the lower end of the lead screw extends to the inside of the lower valve body and is connected to the valve core; the valve core comprises an outer core and an inner core.

### 1. TECHNICAL FIELD

The invention relates to the technical field of valves, in particular to a power-assisted track stop valve.

### 2. BACKGROUND ART

A stop valve relies on the pressure of the valve stem to tightly adhere the sealing surface of the valve disc to the sealing surface of the valve seat, thereby preventing the flow of the medium.

A conventional stop valve is a type of valve that uses a spherical body with a circular through-hole as the disc, and the spherical body rotates or moves up and down along with the valve stem to achieve the opening and closing action. It is mainly used to cut off or connect the medium in the pipeline, and can also be used for the regulation and control of fluid; additionally, it can close any one channel while connecting the other two channels.

In summary, the existing technology utilizes a type of valve that uses a spherical body with a circular through-hole as the disc, and the spherical body rotates or moves up and down along with the valve stem to achieve the opening and closing action. However, this method has the following technical problems: the stop valve is constrained by its structural design, the gate valve requires high processing precision, leading to high costs and large switching torques; additionally, it takes a long time to open and close, and the valve can only withstand unidirectional pressure. Therefore, the invention proposes a new technical scheme: a power-assisted track stop valve to address the technical problems existed in the existing technology.

### 3. SUMMARY OF THE INVENTION

Based on this, it is necessary to provide a power-assisted track stop valve for the above technical problems. Through the overall structural design, it can effectively replace the traditional ball valve design, significantly reduce the precision required for gate valve processing, and cut costs; in addition, the cooperation of the positioning pins and the guiding slots guides the movement of the lead screw, thereby reducing the torque required for switching and shortening the time needed for opening and closing.

To solve the above technical problems, the invention provides the following technical scheme:
a power-assisted track stop valve, which is used in stop valves.

The power-assisted track stop valve specifically comprises:
a lower valve body, an upper valve body is detachably fixed on the top of the lower valve body, a lead screw is arranged inside the upper valve body; positioning pins are arranged on the inner side of the upper part of the upper valve body, guiding slots are arranged on the upper part of the outside of the lead screw at positions corresponding to the positioning pins, the positioning pins on the same side extend to the inside of the guiding slots on the same side;
a valve core, which is arranged inside the lower valve body, the valve core is movably connected to the lower valve body, the lower end of the lead screw extends to the inside of the lower valve body and is connected to the valve core; the valve core comprises an outer core and an inner core, the outer core is vertically arranged inside the lower valve body, a chute is arranged on the inside of the outer core, the slope of the chute is six degrees, the inner core is arranged inside the chute, the inner core is movably connected to the chute, a core baffle is arranged inside the upper end of the lower valve body and above the valve core, the lower end of the lead screw penetrates the core baffle and is connected to the inner core; a sealing column is arranged on the outside of the outer core, and the end of the sealing column away from the outer core is in the shape of a frustum;
an internal slot is arranged inside the upper valve body, a fixed ring is fixedly sleeved on the outside of the lead screw, a rectangular spring is sleeved on the outside of the lead screw, the two ends of the rectangular spring are fixedly connected to the inner wall of the internal slot and the fixed ring respectively;
an O-shaped sealing ring is fixedly connected to the top of the inner core, and a mechanical seal is arranged between the lower part of the valve core and the upper part of the valve core.

As a preferred embodiment of the power-assisted track stop valve provided by the invention, a handwheel is arranged at the top of the upper valve body, a nut is arranged inside the upper end of the upper valve body, the lower end of the handwheel is connected to the nut, the nut is threadedly connected to the lead screw.

As a preferred embodiment of the power-assisted track stop valve provided by the invention, the middle parts of the outer core and the inner core are provided with a second through hole and a first through hole respectively, and the first through hole and the second through hole are oriented in the same direction, the orientation of the first through hole and the sealing column is at a right angle.

As a preferred embodiment of the power-assisted track stop valve provided by the invention, a limiting groove is arranged at the bottom of the inner side of the lower valve body, the limiting groove corresponds to the position of the outer core, a limiting pin is fixed at the lower end of the inner core, the limiting pin passes through the bottom of the outer core and extends to the inside of the limiting groove, the limiting pin is movably connected to the limiting groove.

As a preferred embodiment of the power-assisted track stop valve provided by the invention, the guiding slot is divided into two sections: an upper sliding slot and a lower sliding slot, the upper sliding slot is spiral-shaped, the lower sliding slot is linear.

As a preferred embodiment of the power-assisted track stop valve provided by the invention, a packing assembly for maintenance is arranged in the middle of the upper valve body, the packing assembly comprises a packing gland, a packing port is arranged in the middle of the upper valve body, the packing gland is located inside the packing port, the packing gland is sleeved on the outside of the lead screw, the packing gland is movably connected to the lead screw, the packing gland is fixed by a limiter.

As a preferred embodiment of the power-assisted track stop valve provided by the invention, the limiter comprises a limiting bolt, connecting seats are fixed on both sides of the upper valve body and below the packing port, the lower end of the limiting bolt is rotatably connected to the connecting seat on the same side, both ends of the packing gland extend to the outside of the packing port, the upper end of the limiting bolt is interlocked with the end of the packing gland, a limiting nut is threaded to the top of the limiting bolt and located above the end of the packing gland.

As a preferred embodiment of the power-assisted track stop valve provided by the invention, the upper and lower ends of the lead screw are rotationally connected to the upper valve body through multiple bearings.

As a preferred embodiment of the power-assisted track stop valve provided by the invention, the sealing column is a 30-degree conical sealing surface.

Compared with the existing technology, the invention has the following advantageous:

1. the power-assisted track stop valve provided by the invention, through the overall structural design, can effectively replace the traditional ball valve design, significantly reduce the precision required for gate valve processing, and cut costs; in addition, the cooperation of the positioning pins and the guiding slots guides the movement of the lead screw, thereby reducing the torque required for switching and shortening the time needed for opening and closing.

2. In the invention, through the setted mechanical seal and the O-shaped sealing ring designed on the inner core, these two seal designs block the fluid from entering the middle cavity, while fluid enters the inner core, the liquid pressure acts on the bottom surface of the inner core to generate an upward force, this force generates a leftward force through the inclined column surface to assist in opening the valve, so as to better utilize the energy generated by this force; in addition, the rectangular spring is designed to assist and store energy during the valve opening process, and release energy during the closing process, this helps balance and assist during the opening and closing processes of the valve; therefore, the stop valve in this embodiment can replace the general large-diameter stop valves, as well as commonly used large-diameter fixed hard-seal ball valves and the currently more advanced orbit ball valves. It is bound to play an important role in the fields of oil and gas, coal chemical industry, and nuclear energy.

### 4. BRIEF DESCRIPTION OF ACCOMPANY DRAWINGS

In order to explain the scheme of the invention more clearly, a brief introduction will be given below to the accompanying drawings needed to be used in the description of the embodiments. Obviously, the accompanying drawings in the following description are some embodiments of the invention. For those of ordinary skill in the art, other accompanying drawings can also be obtained based on these accompanying drawings without exerting creative efforts.

FIG. 1 is a schematic diagram of the overall structure of the power-assisted track stop valve provided by the invention;

FIG. 2 is a cross-sectional view of the overall structure of the power-assisted track stop valve provided by the invention;

FIG. 3 is a connection diagram of the overall connection structure of the power-assisted track stop valve provided by the invention;

FIG. 4 is a schematic diagram of the connection structure of the lead screw of the power-assisted track stop valve provided by the invention;

FIG. 5 is a schematic diagram of structures of the positioning pin and guiding slot of the power-assisted track stop valve provided by the invention;

FIG. 6 is a schematic diagram of the structure of the valve core of the power-assisted track stop valve provided by the invention;

FIG. 7 is a schematic diagram of the internal structure of the lower valve body of the power-assisted track stop valve provided by the invention.

FIG. 8 is an enlarged structural view of the packing assembly of the power-assisted track stop valve provided by the invention

FIG. 9 is an enlarged structural view of area A in FIG. 2;

FIG. 10 is a schematic diagram of the structure of the inner core of the invention;

FIG. 11 is a schematic diagram of the structure of the rectangular spring of the invention.

### ATTACHED DINGS MARKS

1 lower valve body; 2 upper valve body; 3 lead screw; 4 valve core; 5 handwheel; 6 outer core; 7 inner core; 8 positioning pin; 9 guiding slot; 10 nut; 11 core baffle; 12 chute; 13 first through hole 13; 14 second through hole; 15 sealing column; 16 limiting pin; 17 limiting groove; 18 packing gland; 19 connecting seat; 20 limiting bolt; 21 limiting nut; 22 internal slot; 23 rectangular spring; 24 fixed ring; 25 mechanical seal; 26 O-shaped sealing ring.

### 5. SPECIFIC EMBODIMENT OF THE INVENTION

In order to enable those skilled in the art to better understand the schemes of the invention, the technical schemes in the embodiments of the invention will be clearly and completely described below in combination with the accompanying drawings in the embodiments of the invention. Obviously, the described embodiments are only part of the embodiments of the invention, not all embodiments. Based on the embodiments of the invention, all other embodiments obtained by those of ordinary skill in the art without creative efforts shall fall within the protection scope of the invention.

As described in the background art, the stop valve is constrained by its structural design, the gate valve requires high processing precision, leading to high costs and large switching torques; additionally, it takes a long time to open and close, and the valve can only withstand unidirectional pressure.

To solve the technical problems, the invention provides a power-assisted track stop valve, which is used in stop valves.

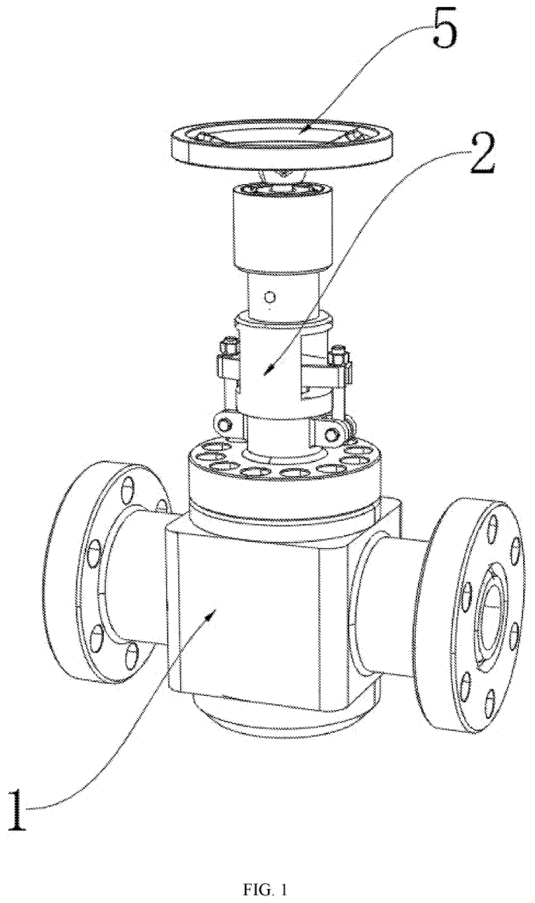

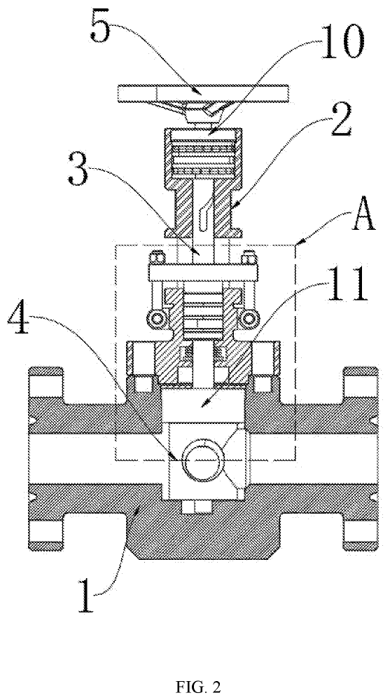

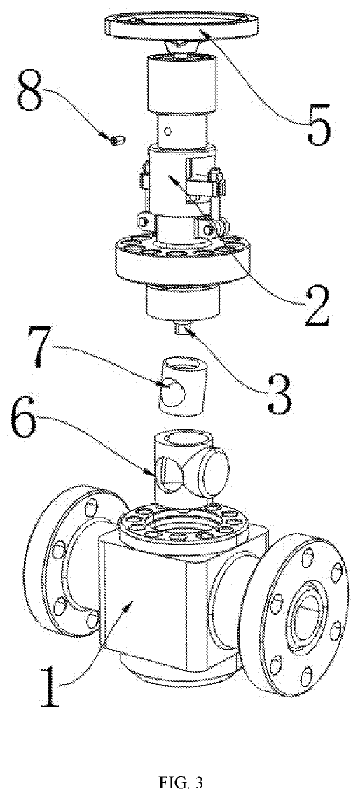

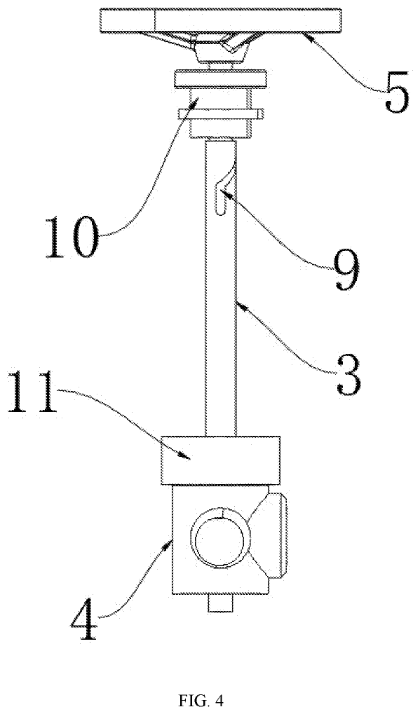

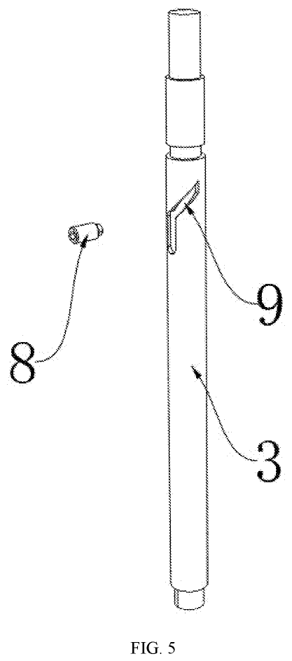

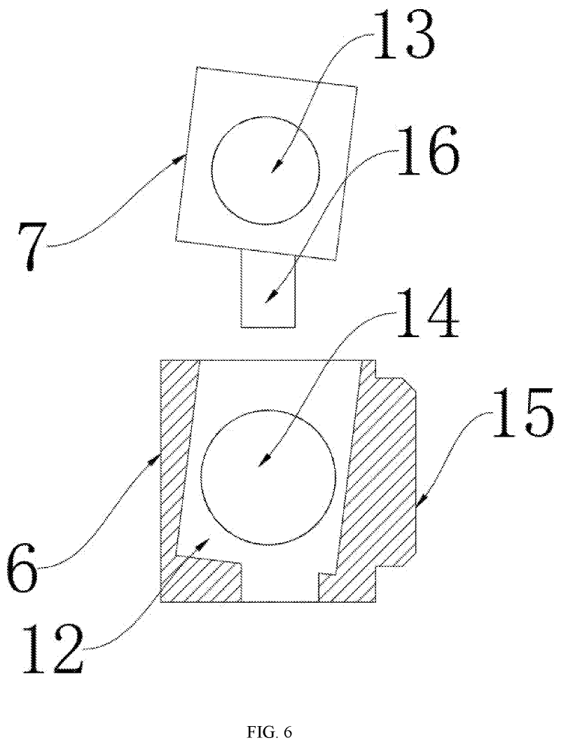

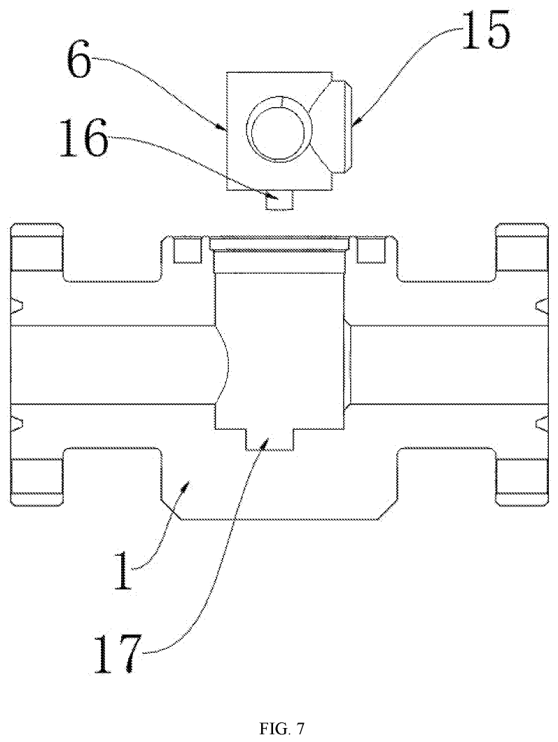

Specifically, please refer to FIG. 1-7, the power-assisted track stop valve specifically comprises:
a lower valve body 1, an upper valve body 2 is detachably fixed on the top of the lower valve body 1, a lead screw 3 is arranged inside the upper valve body 2; positioning pins 8 are arranged on the inner side of the upper part of the upper valve body 2, the sliding fit of vertical inner holes increases the reliability of positioning, guiding slots 9 are arranged on the upper part of the outside of the lead screw 3 at positions corresponding to the positioning pins 8, the positioning pins 8 on the same side extend to the inside of the guiding slots 9 on the same side;
a valve core 4, which is arranged inside the lower valve body 1, the valve core 4 is movably connected to the lower valve body 1, the lower end of the lead screw 3 extends to the inside of the lower valve body 1 and is connected to the valve core 4; the valve core 4 comprises an outer core 6 and an inner core 7, the outer core 6 is vertically arranged inside the lower valve body 1, a chute 12 is arranged on the inside of the outer core 6, the slope of the chute 12 is six degrees, the inner core 7 is arranged inside the chute 12, the inner core 7 is movably connected to the chute 12, a core baffle 11 is arranged inside the upper end of the lower valve body 1 and above the valve core 4, the lower end of the lead screw 3 penetrates the core baffle 11 and is connected to the inner core 7; a sealing column 15 is arranged on the outside of the outer core 6, and the end of the sealing column 15 away from the outer core 6 is in the shape of a frustum, the sealing column is a 30-degree conical sealing surface.

The power-assisted track stop valve provided by the invention, through the overall structural design, can effectively replace the traditional ball valve design, significantly reduce the precision required for gate valve processing, and cut costs; in addition, the cooperation of the positioning pins 8 and the guiding slots 9 guides the movement of the lead screw 3, thereby reducing the torque required for switching and shortening the time needed for opening and closing.

In order to enable those skilled in the art to better understand the schemes of the invention, the technical schemes in the embodiments of the invention will be clearly and completely described below in combination with the accompanying drawings.

### Embodiment 1

please refer to FIG. 1-7, the power-assisted track stop valve specifically comprises:
a lower valve body 1, an upper valve body 2 is detachably fixed on the top of the lower valve body 1, a lead screw 3 is arranged inside the upper valve body 2; the upper and lower ends of the lead screw 3 are rotationally connected to the upper valve body 2 through multiple bearings; in order to facilitate the adjustment of the lead screw 3, a handwheel 5 is arranged at the top of the upper valve body 2, a nut 10 is arranged inside the upper end of the upper valve body 2, the lower end of the handwheel 5 is connected to the nut 10, the nut 10 is threadedly connected to the lead screw 3.

Further, in order to guide and limit the movement of the lead screw 3, positioning pins 8 are arranged on the inner side of the upper part of the upper valve body 2, guiding slots 9 are arranged on the upper part of the outside of the lead screw 3 at positions corresponding to the positioning pins 8, the positioning pins 8 on the same side extend to the inside of the guiding slots 9 on the same side; the guiding slot 9 is divided into two sections: an upper sliding slot and a lower sliding slot, the upper sliding slot is spiral-shaped, the lower sliding slot is linear. During the movement of the lead screw 3, through the cooperation between the upper spiral sliding slots and the positioning pins 8, the lead screw 3 moves upward and rotates, and then through the cooperation between the lower linear sliding slots and the positioning pins 8, the lead screw 3 moves up and down.

A valve core 4, which is arranged inside the lower valve body 1, the valve core 4 is movably connected to the lower valve body 1, the lower end of the lead screw 3 extends to the inside of the lower valve body 1 and is connected to the valve core 4; by adjusting the valve core 4, the opening and closing of the lower valve body 1 is controlled; specifically, the valve core 4 comprises an outer core 6 and an inner core 7, the outer core 6 is vertically arranged inside the lower valve body 1, a chute 12 is arranged on the inside of the outer core 6, the slope of the chute 12 is six degrees, the inner core 7 is arranged inside the chute 12, the inner core 7 is movably connected to the chute 12, a core baffle 11 is arranged inside the upper end of the lower valve body 1 and above the valve core 4, the lower end of the lead screw 3 penetrates the core baffle 11 and is connected to the inner core 7; a sealing column 15 is arranged on the outside of the outer core 6, and the end of the sealing column 15 away from the outer core 6 is in the shape of a frustum, the sealing column is a 30-degree conical sealing surface, the outer core 6 is in contact with the valve seat sealing surface inside the lower valve body 1 through the sealing column 15. By changing the cross-sectional diameter of the front section of lead screw 3, the effect of bidirectional load is realized.

Furthermore, in order to facilitate the rapid flow of media, the middle parts of the outer core 6 and the inner core 7 are provided with a second through hole 14 and a first through hole 13 respectively, the first through hole 13 and the second through hole 14 are oriented in the same direction, so that the medium flowing inside the lower valve body 1 can pass through the inside of the valve core 4 when the valve is open, the orientation of the first through hole 13 and the sealing column 15 is at a right angle, so that the medium flowing inside the lower valve body 1 cannot pass through the inside of the valve core 4 when the valve is closed.

A limiting groove 17 is arranged at the bottom of the inner side of the lower valve body 1, the limiting groove 17 corresponds to the position of the outer core 6, a limiting pin 16 is fixed at the lower end of the inner core 7, the limiting pin 16 passes through the bottom of the outer core 6 and extends to the inside of the limiting groove 17, the limiting pin 16 is movably connected to the limiting groove 17; through the cooperation of the limiting groove 17 and the limiting pin 16, the movement of the valve core 4 can be guided and limited when the valve is opened or closed, so as to avoid the deviation of the valve core 4.

It can be seen that during use, the handwheel 5 on the upper end of the upper valve body 2 is rotated to drive the nut 10 to rotate, through the cooperation between the nut 10 and the lead screw 3, the lead screw 3 drives the inner core 7 to move upward under the guidance of the guiding slots 9 (lower linear sliding slots); through the cooperation between the inner core 7 and the chute 12, the inner core 7 drives the outer core 6 to move laterally during its upward movement, this movement separates the sealing column 15 on the outer side of the outer core 6 from the sealing surface of the valve seat inside the lower valve body 1; by continuously rotating the handwheel 5, the lead screw 3 continues to move upward, and the inner core 7 is driven to rotate under the guidance of the guiding slots 9 (the upper spiral sliding slots), so that the outer core 6 rotates to open the flow channel and open the valve.

On the contrary, when the handwheel 5 is rotated in the opposite direction, it drives the nut 10 and the lead screw 3 to move downward, the lead screw 3 drives the inner core 7 to rotate and aligns it with the sealing surface of the valve seat inside the lower valve body 1 under the guidance of the guiding slots 9 (upper spiral sliding slots); the lead screw 3 continues to move downward and cooperates the guidance of the guiding slots 9 (lower linear sliding slots) to make the inner core 7 go down; the cooperation between the inner core 7 and the chute 12 forces the outer core 6 to move laterally and resets the outer core 6, so that the reset outer core 6 presses against the sealing surface of the valve seat inside the lower valve body 1 through the external sealing column 15, and the valve is closed.

### Embodiment 2

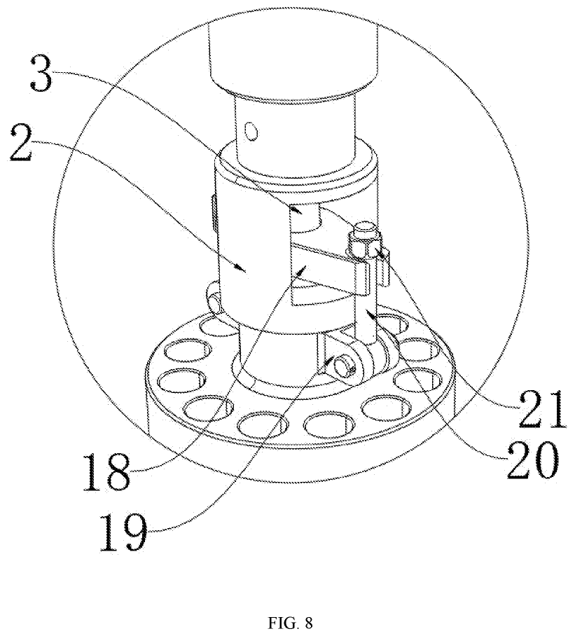

The power-assisted track stop valve provided in Embodiment 1 is further optimized, specifically, as shown in FIG. 8, a packing assembly for maintenance is arranged in the middle of the upper valve body 2, the packing assembly comprises a packing gland 18, a packing port is arranged in the middle of the upper valve body 2, the packing gland 18 is located inside the packing port, the packing gland 18 is sleeved on the outside of the lead screw 3, the packing gland 18 is movably connected to the lead screw 3, the packing gland 18 is fixed by a limiter.

Specifically, the limiter comprises a limiting bolt 20, connecting seats 19 are fixed on both sides of the upper valve body 2 and below the packing port, the lower end of the limiting bolt 20 is rotatably connected to the connecting seat 19 on the same side, both ends of the packing gland 18 extend to the outside of the packing port, the upper end of the limiting bolt 20 is interlocked with the end of the packing gland 18, a limiting nut 21 is threaded to the top of the limiting bolt 20 and located above the end of the packing gland 18.

Through the above structural design, when the valve needs to be maintained, the limiting nut 21 can be removed from the top of the limiting bolt 20, thereby releasing the limit for the movement of the limiting bolt 20 and simultaneously releasing the limit for the movement of the packing gland 18, then the packing gland 18 can be moved upward, and then the lubricating medium can be added to the lower end of the packing gland 18 to maintain the valve.

### Embodiment 3

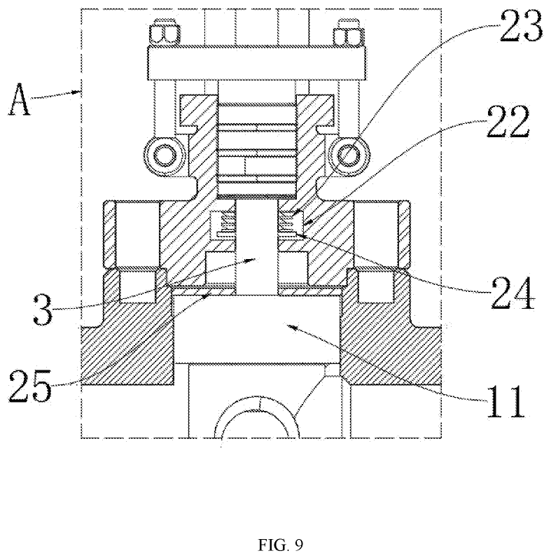

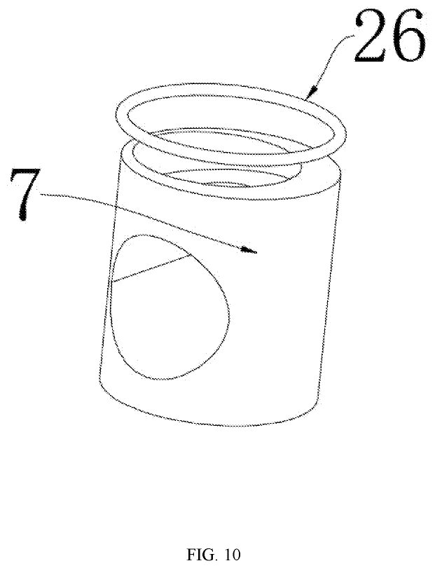

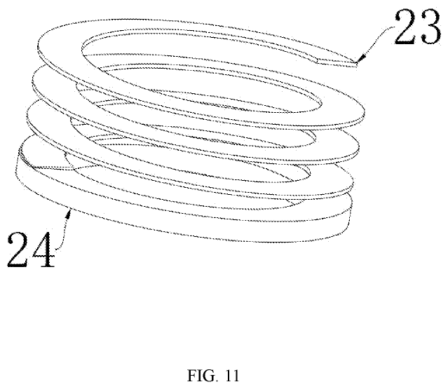

Referring to FIGS. 1 to 11, what is different from other embodiments is that the specific scheme in this embodiment comprises that an internal slot 22 is arranged inside the upper valve body 2, a fixed ring 24 is fixedly sleeved on the outside of the lead screw 3, a rectangular spring 23 is sleeved on the outside of the lead screw 3, the two ends of the rectangular spring 23 are fixedly connected to the inner wall of the internal slot 22 and the fixed ring 24 respectively;
an O-shaped sealing ring 26 is fixedly connected to the top of the inner core 7, and a mechanical seal 25 is arranged between the lower part of the valve core 4 and the upper part of the valve core 4.

The above technical solution is explained as follow: through the setted mechanical seal 25 and the O-shaped sealing ring 26 designed on the inner core 7, these two seal designs block the fluid from entering the middle cavity, while fluid enters the inner core 7, the liquid pressure acts on the bottom surface of the inner core 7 to generate an upward force, this force generates a leftward force through the inclined column surface to assist in opening the valve, so as to better utilize the energy generated by this force.

In addition, the rectangular spring 23 is designed to assist and store energy during the valve opening process, and release energy during the closing process, this helps balance and assist during the opening and closing processes of the valve.

Therefore, the stop valve in this embodiment can replace the general large-diameter stop valves, as well as commonly used large-diameter fixed hard-seal ball valves and the currently more advanced orbit ball valves. It is bound to play an important role in the fields of oil and gas, coal chemical industry, and nuclear energy.

1. A power-assisted track stop valve comprises:
a lower valve body, an upper valve body is detachably fixed on the top of the lower valve body, a lead screw is arranged inside the upper valve body; positioning pins are arranged on the inner side of the upper part of the upper valve body, guiding slots are arranged on the upper part of the outside of the lead screw at positions corresponding to the positioning pins, the positioning pins on the same side extend to the inside of the guiding slots on the same side;
a valve core, which is arranged inside the lower valve body, the valve core is movably connected to the lower valve body, the lower end of the lead screw extends to the inside of the lower valve body and is connected to the valve core; the valve core comprises an outer core and an inner core, the outer core is vertically arranged inside the lower valve body, a chute is arranged on the inside of the outer core, the slope of the chute is six degrees, the inner core is arranged inside the chute, the inner core is movably connected to the chute, a core baffle is arranged inside the upper end of the lower valve body and above the valve core, the lower end of the lead screw penetrates the core baffle and is connected to the inner core; a sealing column is arranged on the outside of the outer core, and the end of the sealing column away from the outer core is in the shape of a frustum;
an internal slot is arranged inside the upper valve body, a fixed ring is fixedly sleeved on the outside of the lead screw, a rectangular spring is sleeved on the outside of the lead screw, the two ends of the rectangular spring are fixedly connected to the inner wall of the internal slot and the fixed ring respectively;
an O-shaped sealing ring is fixedly connected to the top of the inner core, and a mechanical seal is arranged between the lower part of the valve core and the upper part of the valve core.

2. The power-assisted track stop valve of claim 1, a handwheel is arranged at the top of the upper valve body, a nut is arranged inside the upper end of the upper valve body, the lower end of the handwheel is connected to the nut, the nut is threadedly connected to the lead screw.

3. The power-assisted track stop valve of claim 2, the middle parts of the outer core and the inner core are provided with a second through hole and a first through hole respectively, and the first through hole and the second through hole are oriented in the same direction, the orientation of the first through hole and the sealing column is at a right angle.

4. The power-assisted track stop valve of claim 3, a limiting groove is arranged at the bottom of the inner side of the lower valve body, the limiting groove corresponds to the position of the outer core, a limiting pin is fixed at the lower end of the inner core, the limiting pin passes through the bottom of the outer core and extends to the inside of the limiting groove, the limiting pin is movably connected to the limiting groove.

5. The power-assisted track stop valve of claim 4, the guiding slot is divided into two sections: an upper sliding slot and a lower sliding slot, the upper sliding slot is spiral-shaped, the lower sliding slot is linear.

6. The power-assisted track stop valve of claim 5, a packing assembly for maintenance is arranged in the middle of the upper valve body, the packing assembly comprises a packing gland, a packing port is arranged in the middle of the upper valve body, the packing gland is located inside the packing port, the packing gland is sleeved on the outside of the lead screw, the packing gland is movably connected to the lead screw, the packing gland is fixed by a limiter.

7. The power-assisted track stop valve of claim 6, the limiter comprises a limiting bolt, connecting seats are fixed on both sides of the upper valve body and below the packing port, the lower end of the limiting bolt is rotatably connected to the connecting seat on the same side, both ends of the packing gland extend to the outside of the packing port, the upper end of the limiting bolt is interlocked with the end of the packing gland, a limiting nut is threaded to the top of the limiting bolt and located above the end of the packing gland.

8. The power-assisted track stop valve of claim 7, the upper and lower ends of the lead screw are rotationally connected to the upper valve body through multiple bearings.

9. The power-assisted track stop valve of claim 8, the sealing column is a 30-degree conical sealing surface.
